(19) United States
(12) Patent Application Publication
(10) Pub. No.: US 2026/0352671 A1
(43) Pub. Date: Nov. 5, 2026

(54) SYSTEM AND METHOD FOR IDENTIFYING AND PREVENTING MULTI-FACTOR AUTHENTICATION THEFT

(71) Applicant: Gen Digital Inc., Tempe, AZ (US)

(72) Inventors: Iskander Sanchez-Rola, Redwood City, CA (US); Balu Mohan, Somu Nagar (IN); Ramalingam Srinivasan, Nolambur (IN)

(73) Assignee: Gen Digital Inc., Tempe, AZ (US)

(21) Appl. No.: 19/197,898

(22) Filed: May 2, 2025

(51) Int. Cl. H04L 9/40

(52) U.S. Cl. CPC H04L 63/123; H04L 2463/082; H04L 2463/121

(57) ABSTRACT

A system and method for identifying and preventing theft or unauthorized use of multi-factor authentication (MFA) credentials by correlating MFA messages with real-time user activity. The system includes a processor, memory, and storage configured to receive MFA messages via SMS, email, or app notifications, and to monitor applications or browser tabs currently active on a user device. A multi-factor authentication module includes a notification detection module, a user activity monitoring module, a contextual matching module, and a response and alerting module. The contextual matching module generates a confidence score based on a comparison between the MFA message origin and the user's concurrent activity. Based on this score, the system suppresses, alerts, or blocks suspicious MFA messages. The system operates in real-time and simultaneously across modules to detect phishing and impersonation attacks, and enhances security by verifying whether MFA requests correspond with legitimate, user-initiated behavior.

### FIELD

The present invention relates generally to multi-factor authentication, and more specifically to systems and methods for identifying and preventing multi-factor authentication theft.

### BACKGROUND

Online accounts and digital services are increasingly protected using multi-factor authentication (MFA), which enhances security by requiring users to present multiple pieces of evidence to verify their identity rather than relying only on usernames and passwords. In typical implementations, MFA systems combine information that the user knows (such as a password) with something the user has (such as a smartphone, computer, or telephone) that is capable of receiving an authentication code, or something the user is (such as the user's biometric data). In a common scenario, implementations of MFA include sending one-time passcodes (OTPs) via SMS or email to a device accessible to the user, or generating time-based codes using dedicated authenticator apps. These multi-factor authentication systems and methods add a critical second layer of defense against access to a user's accounts.

However, despite their intended purpose and the increased security that MFA systems generally provide, the MFA systems themselves are not immune to attack or exploitation. In response to MFA and increased credential security in general, cybercriminals have likewise developed increasingly sophisticated techniques for intercepting MFA codes and exploiting them to gain unauthorized access to user accounts.

One frequently employed method to attempt to bypass MFA authentication is the use of man-in-the-middle (MitM) phishing attack, where cybercriminals create convincing replicas of legitimate login pages, such as for banking, payment, social media, and other commonly used websites. When an unsuspecting user enters their credentials and their MFA code into the replica site, the attacker captures that information in near real-time and immediately uses it to access the legitimate service through the legitimate website-using the user's captured credentials and the MFA code sent to the user in response to the cybercriminal entering the captured information into the legitimate website. Because the MFA code was issued by the legitimate website and was received back as confirmation by the legitimate website (by the cybercriminal), access to the user's account is granted. Thus, while multi-factor authentication was technically in use by the user and by the legitimate website, the MFA failed to provide the intended protection to the user and to the website.

In addition to man-in-the-middle attacks, further vulnerabilities to MFA arise from the channels or communications means used to deliver MFA codes. For example, SMS messages can be intercepted through SIM swapping attacks (e.g., transferring a user's mobile account to a SIM card controlled by a bad actor) or by exploiting other weaknesses in cellular networks. In other attacks, emails containing authentication codes may be accessible to attackers if the user's email account has been compromised, or if the attacker manages to trick the user into forwarding such messages. Even app-based authenticators, while generally more secure than SMS or email MFA authentication, are susceptible to overlay attacks (e.g., a false user interface is overlaid onto the actual user interface of the authenticator) or to unauthorized notification access on poorly secured devices. In each case, the legitimate user is often unaware that their MFA credentials have been intercepted.

Traditional multi-factor authentication systems are premised on the assumption that the request for authentication is legitimate as long as the correct code is supplied in response. However, this traditional model fails to account for the actual context in which the MFA interception attempt occurs. For example, if a user receives an MFA code from an online service such as Facebook while that user is not actively attempting to log in to Facebook, the MFA system itself has no way of recognizing the discrepancy because the MFA system has no context as to the user's activity at the time of the MFA request. As a result, traditional MFA systems may inadvertently aid attackers or bad actors by delivering MFA codes that can be immediately exploited especially in real-time phishing scenarios where the attacker and the victim are concurrently interacting with different interfaces.

Furthermore, existing anti-phishing measures typically focus on detecting malicious domains or flagging suspicious emails. These measures can be effective but are reactive in nature, relying on prior knowledge of the threats. This leaves a large gap in protection for zero-day phishing domains and other adaptive attack methods. In such cases, the traditional MFA process itself becomes the weakest link in the chain, as it does not validate whether the authentication request originated from a user-initiated action or from an attacker impersonating the user in real time.

While MFA remains a valuable component of digital security, its limitations are increasingly being exploited by attackers who are able to manipulate timing, context, and user trust. The growing prevalence of real-time phishing, notification hijacking, and device compromise shows that cybercriminals can and will exploit fundamental weaknesses in conventional MFA implementations. Thus, it can be seen that there remains a need in the art for improved multi-factor authentication systems that can detect and prevent interception and theft of authorized users'MFA codes and credentials.

### SUMMARY

The present invention is directed to systems and methods for identifying and preventing theft or unauthorized use of multi-factor authentication (MFA) credentials by analyzing and interpreting the real-time context in which MFA codes are received and used.

Although MFA is widely used to enhance account security, conventional MFA systems are vulnerable to phishing and man-in-the-middle (MitM) attacks that can bypass the MFA security layer. The present invention provides a proactive security system that correlates MFA messages (such as one-time passcodes received via SMS, email, or app notifications) to actual user-initiated actions and real-time user activity, thereby allowing the system of the present invention to distinguish between legitimate and potentially fraudulent MFA requests.

In one exemplary embodiment, the system comprises one or more processors, memory, and storage configured to detect incoming MFA communications across various channels, including SMS messages, emails, and application notifications. The system may be implemented on a user's mobile device, laptop, or desktop computer, and may operate in conjunction with browser extensions or native application services to collect and analyze authentication data (e.g., MFA codes) and corresponding user activity. Communication may occur locally on the user's device(s), or across public or private networks to support cloud-based MFA security services.

In one aspect, the system includes software running on the processors configured to monitor, analyze, and interpret incoming authentication communications (e.g., MFA codes), identify the origin and/or associated service provider of the MFA code, and verify whether the code request corresponds to the user's real-time behavior.

For example, the system may determine whether a particular MFA code originating from Facebook is received while the user's Facebook app is open or while the user is actively browsing at “facebook.com” i.e., determine whether the user is actually using Facebook at the time of receiving the MFA code. If the authentication message originates from a recognized provider but the user is not engaged in a matching activity, the system may initiate a protective response to suppress, block, or alert the user regarding the suspicious authentication attempt. For instance, if the user is not the legitimate Facebook site, but is instead at a bogus site, such as “faceb00k-login.com”, the system may recognize the mismatch between the MFA code's origin (i.e., from the actual Facebook) and the user's current activity (i.e., at a non-Facebook site).

In operation, the system continuously and in real-time evaluates both the source of incoming MFA codes and communications and the concurrent user activity at the moment the message is received. The system may use platform-specific tools to monitor and gather real-time contextual information, such as accessibility services, usage statistics, browser tab monitoring, and notification listeners.

Upon receipt of an MFA code, a determination is made as to whether the MFA code is likely to have been solicited by the user (e.g., if the user was actively using a legitimate app or website corresponding to the originator of the MFA code), or if the MFA code was delivered in a context that suggests phishing or impersonation may be taking place. Based on this determination and analysis, the system dynamically controls whether the MFA code is displayed to the user, displayed and flagged to the user, or whether it should be completely hidden or blocked from the user.

In a further aspect, the system may integrate with anti-phishing and endpoint protection software, thus providing an additional behavioral layer of security that does not depend on phishing domain detection or blacklist databases or lists. Rather than simply relying on identifying known malicious patterns, the system of the present invention operates on a whitelist-based validation approach, i.e., determining whether an MFA code is expected based on the legitimate user's current actions and the state of the user's device. This approach to MFA security provides effective protection even in zero-day phishing scenarios, where the attacker's infrastructure is unknown or newly created and thus does not yet appear on anti-phishing blacklists.

The system and method of the present invention thus provides users with enhanced multi-factor authentication security that is context-based and behaviorally aware, and is capable of operating in real-time to detect and thwart attempts to intercept MFA credentials as they occur. The system significantly reduces or eliminates the effectiveness of bad actors'phishing and MitM attacks by ensuring that MFA authentication codes are only allowed when they correspond with legitimate user-initiated behavior. Thus, the invention as claimed improves the security model of MFA systems by adding a real-time contextual verification layer that operates transparently and seamlessly with user apps and web activity.

As used herein, the term “real-time” refers to the execution of computational processes, including MFA code and user activity analysis and response determination at a speed and efficiency that enables immediate interaction without perceptible delay to the user. In this context, “real-time” denotes a level of rapid processing that would be infeasible for a human to perform manually within a practical timeframe. Similarly, the term “simultaneously” as used herein with respect to computer processes denotes concurrent processing that would be infeasible for a human to perform manually within a practical timeframe.

The details of one or more exemplary embodiments of the system and method of the present invention are set forth in the accompanying drawings and the description below. Other features and advantages will be apparent from the description and drawings, and from the claims.

### BRIEF DESCRIPTION OF THE DRAWINGS

FIG. 1 is a block diagram of a system for identifying and preventing theft of Multi-Factor Authentication (MFA) credentials in accordance with an exemplary embodiment of the present invention.

FIG. 2 is a flow diagram of MFA notification detection implemented in a system for identifying and preventing MFA theft in accordance with an exemplary embodiment of the present invention.

FIG. 3 is a flow diagram of user activity analysis implemented in a system for identifying and preventing MFA theft in accordance with an exemplary embodiment of the present invention.

FIG. 4 is a flow diagram of contextual verification and threat detection implemented in a system for identifying and preventing MFA theft in accordance with an exemplary embodiment of the present invention.

FIG. 5 is a flow diagram of alerting, suppression, and defensive response mechanisms implemented in a system for identifying and preventing MFA theft in accordance with an exemplary embodiment of the present invention.

FIG. 6 is a block diagram of a computerized system for identifying and preventing MFA theft in accordance with an exemplary embodiment of the present invention.

### DETAILED DESCRIPTION

In the following detailed description of exemplary embodiments, reference is made to specific embodiments by way of drawings and illustrations. These examples are described in sufficient detail to enable those skilled in the art to practice what is described and serve to illustrate how elements of these examples may be applied to various purposes or embodiments. Other embodiments exist, and logical, mechanical, electrical, and other changes may be made to the exemplary embodiments without deviating from the scope of the invention claimed herein.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations are explicitly contemplated to be within the scope of the examples presented here. The following detailed description does not, therefore, limit the scope of what is claimed.

Multi-Factor Authentication (MFA) has become an industry standard for securing user accounts across consumer and commercial computer systems. MFA typically introduces a second authentication step-such as a one-time code—delivered to a user via SMS, email, or app-based notification. Entry of the MFA code by the user into a legitimate website or application allows the website to authenticate the user—i.e., the user requested and received the MFA code, and entered into the website, thus the user must be legitimate. However, despite its potential to increase security and authenticate legitimate users, MFA itself has become a target for attackers and cybercriminals. For example, real-time interception techniques, such as man-in-the-middle (MitM) attacks and phishing pages that mimic or mirror trusted login portals, may be employed by bad actors to obtain and use MFA codes before legitimate users may recognize that they have been deceived.

Such attacks typically exploit the fundamental trust assumptions underlying MFA. For example, an attacker may simulate a login request on a legitimate service, triggering an MFA code to be sent to the legitimate user. If the user is simultaneously engaged with a spoofed or cloned version of the service under the control of the attacker-unaware that it is not the authentic platform or service—they may voluntarily enter the MFA code into the attacker's interface, unknowingly granting access to their account. Because traditional MFA systems validate only the entry of a correct MFA code, they do not evaluate the context in which the code was generated or entered, leaving open a critical path for exploitation by bad actors.

Exemplary embodiments of the present invention as described herein address this potential exploitation by providing systems and methods for dynamically linking and/or correlating incoming MFA codes to real-time user activity. Rather than treating MFA codes as inherently valid, as traditional systems do, the systems and methods of the present invention evaluate whether the incoming MFA notification corresponds to an active, user-initiated action, typically on the same device. If the user receives a Google MFA code on a device, for example, the system verifies whether the user was engaged with a legitimate Google-related application or domain at the moment the code was received. If not, the system classifies the event as inconsistent and may thus trigger an alert, suppression, or blocking of the received MFA code.

In one exemplary embodiment, the system comprises one or more processors, a memory, a storage medium, and communication hardware configured to receive, analyze, and correlate MFA messages with local device context. The system may operate as software executing on a user device, such as a mobile phone, desktop, or browser extension, may be executed as a portal or software service accessed by the user, or may be deployed as part of a local security architecture in a manner similar to local firewalls, with hardware and/or software implementing the protective system and method.

In operation, the system detects and captures MFA events from multiple notification channels, monitors user activity in real time, and evaluates whether the source of the MFA code and the user's ongoing activity correlate, thus allowing a determination as to whether the MFA code and the user's activity are likely legitimate.

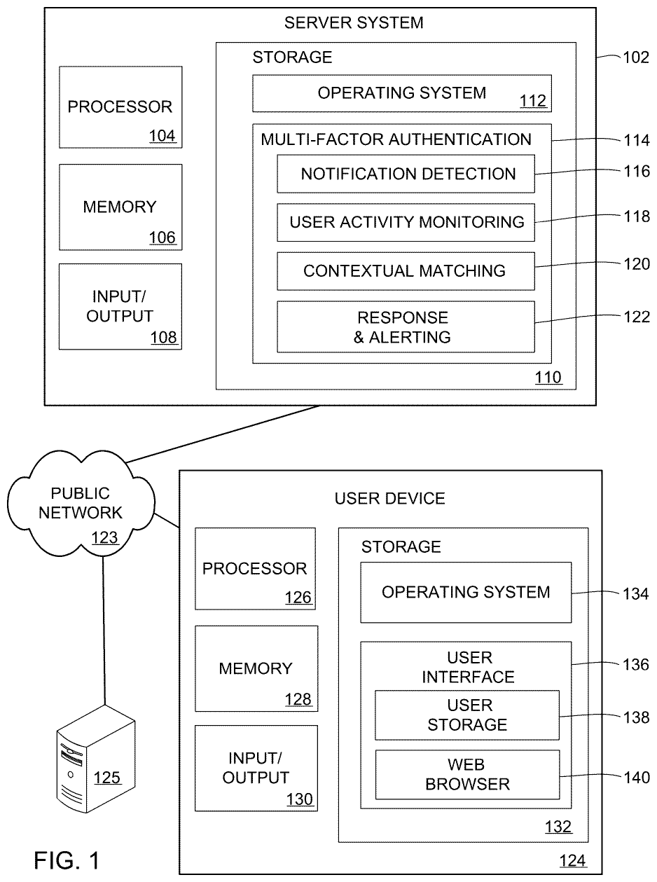

As described in detail below with reference to FIG. 1, the system preferably comprises a plurality of software modules, collectively referred to as the multi-factor authentication module. The modules include: a notification detection module, a user activity monitoring module, a contextual matching module, and a response and alerting module. Each module performs specific detection, evaluation, and/or response operations that together enable the system to dynamically assess and react to MFA events that appear to be inconsistent or unauthorized.

The notification detection module is configured to identify incoming MFA messages across various apps, websites, or other channels in communication with the user's device. These include SMS messages received through mobile frameworks (e.g., Android's SMS content providers or iOS's MessageUI), email messages retrieved via secure application programming interfaces (APIs), and app-based push notifications captured using platform-specific notification listeners. For example, the NotificationListenerService on Android may be used to monitor incoming notifications from apps such as Google Authenticator, Microsoft Authenticator, or various financial services. Upon receipt of a notification, the notification detection module parses the content and metadata of each received message to determine whether it is MFA related, and, if so, extracts key identifiers such as the sender's phone number, the email domain where the MFA code originated, the app notification tag, or other relevant information.

Once a message has been identified as MFA related, the notification detection module associates or correlates the notification with a known service by comparing information and data received with the message with known information about the purported sender. For example, by comparing sender metadata such as an SMS phone number (e.g., 555-2368 for Facebook) or an email address domain (e.g., no-reply@mailtwitch.com) to a reference database of verified service providers the module can determine if the sender data matches the expected, known, information of the purported sender. Thus, the system may classify the originator of the MFA request and forward both the classification and the original message metadata to the contextual matching module for further evaluation, as will now be discussed.

Simultaneously with the MFA notification detection module, a user activity monitoring module continuously and in real-time evaluates the current activity state of the user's device to determine which application is currently in the foreground or which browser tab is actively in use on the device. For example, on Android devices, the system may use UsageStatsManager or AccessibilityService APIs to determine the name of the running foreground app. On other devices, the system may use corresponding APIs specific to those devices. In desktop or browser environments, the system may use the browser. tabs API to identify and determine which tab is currently focused, along with the domain associated with the tab. Monitoring of activity on the user device occurs in real time, simultaneously with the operation of the notification detection module, and is preferably timestamped for correlation with any incoming messages.

It should be understood that user activity monitoring is not limited to single applications and/or simple snapshots of activity. In some embodiments, the system may maintain session-based records of recent user activity, including transitions between various apps, browsers, user interactions, and input focus changes. Thus, the system may identify cases in which a user may have recently initiated an action relevant to the MFA request, even if an exact match to the action has not yet surfaced in a foreground context or focus.

With the notification detection module and user activity monitoring modules operational as just described, the system is able to provide real-time contextual verification to identify and assess incoming MFA codes. Rather than assuming all incoming MFA codes are legitimate, as is the case with known MFA systems, the system and method of the present invention may evaluate correlations between user activity and the origin of an MFA code (or MFA code request), such that the system and method of the present invention may distinguish between legitimate, user-initiated MFA events and potentially malicious, attacker-triggered requests.

Turning to FIG. 1, a block diagram of a system 102 for identifying and preventing theft of MFA credentials is depicted in accordance with an exemplary embodiment of the present invention. The system 102 comprises a computing platform, such as a mobile device, desktop client, or dedicated server, configured to detect MFA messages, monitor device activity, analyze contextual alignment, and initiate protective actions. The components of system 102 include one or more processors 104, a memory 106, input/output hardware and software 108, and a storage medium 110. These components work in coordination to host and execute software modules responsible for real-time detection, analysis, and mitigation of suspicious MFA activity.

Storage 110 includes non-transitory computer-readable memory for storing executable program instructions. These include an operating system 112 and a plurality of software components collectively referred to as the multi-factor authentication module 114. The operating system 112 provides basic services such as memory management, file access, and network communication, and supports APIs necessary for message interception and user activity monitoring. In some embodiments, the operating system may also provide access to device-level communications, such as accessibility events or input focus changes, which may allow further monitoring of user behavioral characteristics.

The multi-factor authentication module 114 comprises four submodules, each responsible for a specific aspect of the detection and response pipeline. The notification detection module 116 is configured to intercept and parse incoming messages and/or notifications from SMS, email, or app-based channels. This module thus identifies whether a message is an MFA request or code and extracts metadata such as sender information and authentication code patterns.

The user activity monitoring module 118 captures real-time information about the applications or browser tabs in use (or recently used) by the user. This includes tracking which app is in the foreground, the domain of the active browser tab, and a short history of recent interactions with apps and browser tabs.

The contextual matching module 120 receives both the message metadata and activity data from the two modules as just discussed, and determines whether the user's current or recent behavior aligns or corresponds with the service that issued the MFA request. This module further computes a confidence score indicating the legitimacy of the authentication event based on various factors as discussed in more detail below.

The response and alerting module 122 executes protective actions based on the computed confidence score. These actions may include hiding the MFA code, blocking it from delivery, generating and presenting user alerts in conjunction with the code, or logging the event for further review.

Each of the modules within multi-factor authentication module 114 may be implemented as discrete software components that communicate through a shared memory space or message-passing framework. In preferred embodiments, the modules may operate in parallel as independent threads or services. For example, the notification detection module 116 may run as an always-on background service that triggers downstream analysis as messages are received. Similarly, the user activity monitoring module 118 may sample device context at a fixed interval (e.g., every 100 milliseconds), ensuring up-to-date behavioral snapshots are always available for comparison.

As used herein, the term “module” refers to a set of software and/or hardware components configured to perform specific tasks within a computing environment. A module may be implemented as a standalone application, background service, dynamic library, or script executing within the system's runtime environment. Modules may also be containerized or distributed across a network in hybrid cloud-device configurations. It should be understood that the modules as depicted in the exemplary embodiments herein are generally separate, independent modules, but in other embodiments the various modules may be combined differently or may share functionality. These and other configurations are within the scope of the present invention.

In some embodiments, each module may be embodied as a computer-readable instruction set stored in storage 110 and executed by processor 104. For example, the notification detection module 116 may comprise parsing routines, pattern classifiers, and service recognition logic that collectively enable accurate identification of MFA messages. Similarly, the contextual matching module 120 may implement a scoring engine, comparison operators, and decision trees to evaluate correlation and alignment between the origin of a message and the context of user activity.

In some embodiments, the modules may be further structured as asynchronous services communicating through inter-process communication (IPC) mechanisms such as message queues, broadcast listeners, or shared event buses. For example, when the notification detection module 116 identifies an MFA message, it may queue a processing event with associated metadata, which is then processed by the contextual matching module 120. Various other configurations and designs may be implemented in accordance with the present invention to ensure efficient system performance on smaller or resource-limited devices, such as mobile devices, tablets, smartphones, and the like.

Looking still to FIG. 1, system 102 is in communication via a public network 123-such as the Internet or a local Wi-Fi network-to one or more user devices 124 or other remote client computing devices 125, with communication to and from the server 120 facilitated by input/output 108 hardware and software on the server system. The user devices 124 include smartphones, tablets, laptops, or desktops that receive MFA messages and provide contextual data for behavioral verification. Each device 124 preferably includes a processor 126, memory 128, input/output components 130 (such as a screen, keyboard, microphone, or touchscreen), storage 132, an operating system 134, and a user interface module 136.

The user interface module 136 may include both local and web-based interfaces for interacting with the system 102. In one embodiment, a web browser 140 is provided for user login and system configuration. The user interface enables interaction with detected alerts, configuration of response thresholds, and review of historical logs. For example, if the system suppresses a potentially suspicious MFA message, the user may view a notification such as: “An MFA code from Twitch was received while no Twitch-related activity was detected. This may indicate phishing.”

User storage 138 preferably provides persistent, non-volatile memory for logging received MFA messages, associated service metadata, activity snapshots, confidence scores, and user responses. This local storage allows the system to function offline and enables the user to review prior MFA events, correct false positives, or refine or adjust detection sensitivity settings. In cloud based embodiments, the user data may be securely uploaded to a remote server for aggregate analysis or integration with enterprise security platforms.

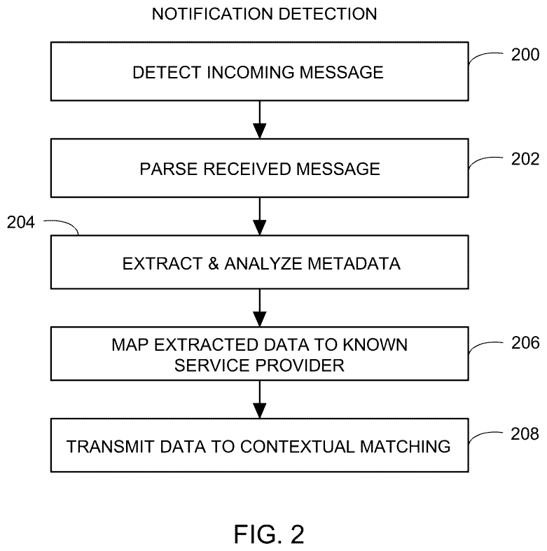

With the system architecture and hardware configuration set forth above, the operation of the system and method for identifying and preventing MFA theft will now be described with reference to the flow diagrams of FIGS. 2 through 5, which illustrate exemplary steps performed by the software modules of system 102 and/or in the user device 124 or computing device 125 in an exemplary embodiment of the present invention.

Turning first to FIG. 2, a flow diagram of an exemplary embodiment of steps performed by the notification detection module 116 is depicted. As discussed briefly above, this module is configured to intercept and analyze messages that may contain authentication codes delivered through SMS, email, or push notification services.

At block 200, the system detects an incoming message on the user device. Depending on the operating platform, the message may be received via an SMS broadcast intent, a registered notification listener, or an email API call. The system preferably includes event listeners that operate at the operating system level to ensure that notifications are captured in real time.

At block 202, the content of the received message is parsed. The parsing engine uses a combination of regular expressions, heuristics, and rule-based classifiers to identify patterns typically associated with MFA codes. Common formats may include six-digit or eight-digit numbers, alphanumeric passcodes, and known phrases such as “Your code is” or “Use this code to log in.”

At block 204, the system extracts and analyzes sender metadata. For SMS messages, this may include the originating phone number (e.g., +1-888-555-2368), while email messages are evaluated based on domain names and header information. App-based notifications are matched using the sender app's package name and/or notification channel ID.

At block 206, the system maps the extracted sender identity to a known service provider using a pre-established database of verified MFA sources—i.e. a whitelist. For example, the sender “no-reply@mailtwitch.com” may be mapped to Twitch, and a push notification from “com.facebook.katana” may be mapped to Facebook. If the sender is not present in the reference database, the message may be marked as “unknown” or processed using similarity matching against known patterns.

At block 208, the identified MFA notification, along with its parsed metadata, is transmitted to the contextual matching module 120 for further evaluation. The event is also preferably logged in system storage 138 for later review, audit and learning purposes.

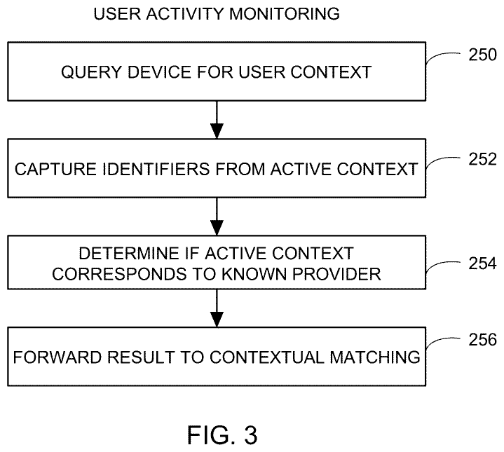

Turning to FIG. 3, a flow diagram of an exemplary embodiment of steps performed by the user activity monitoring module 118 is depicted. As discussed briefly above, this module continuously collects information about the active state (or recently active state) of the user device to determine what applications or websites the user is engaged with at the moment an MFA message is received.

At block 250, the module queries the device for its current user context. For example, on Android devices, this may involve invoking the UsageStatsManager API to determine which application is in the foreground. On desktop platforms or web browsers, the module may query the browser. tabs. query( ) API to determine the active tab and its associated domain. Other platforms and devices will have similarly functioning APIs that provide the desired information.

At block 252, the module captures relevant identifiers from the active context, such as the app package name (e.g., com.google.android.gm), browser domain (e.g., accounts.google.com), timestamp, and input state (e.g., keyboard activity, touch event). This information is preferably stored in an activity buffer in memory 106 for correlation with incoming MFA events.

At block 254, the system determines whether the active context corresponds to the service identified in the MFA message. For example, if the message was determined to originate from Twitch, the module checks whether the user was actively using the Twitch app or browsing twitch. tv in the moments leading up to the MFA message receipt. At block 256, the result of the comparison is forwarded to the contextual matching module along with an activity snapshot and timeline for more refined scoring.

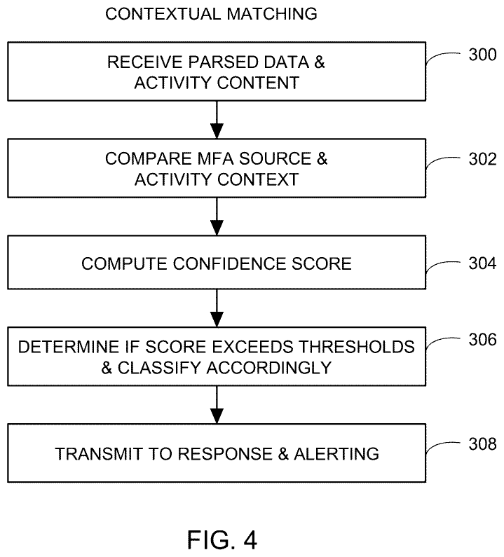

Turning now to FIG. 4, a flow diagram of an exemplary embodiment of steps performed by the contextual matching module 120 is depicted. This module, as discussed briefly above, receives inputs from both the notification detection and activity monitoring modules and determines whether an incoming MFA request is contextually valid.

Thus, at block 300, the module receives parsed MFA message data with an associated service identifier, and current and recent user activity context, including the foreground app, domain names, and interaction metadata.

At block 302, the module compares the MFA source and the corresponding user activity. This comparison includes matching the identified service (e.g., Google) to app package names (com.google.*) or verified domains (*.google.com). Depending on the desired implementation and configuration, the comparison may be strict/literal, or may include a tolerance or “closeness” factor. For example, “connect.googlemail.com” may raise a warning flag due to its similarity to a trusted domain but its absence from the whitelist or database.

At block 304, the module computes a confidence score summarizing in numerical terms the likelihood that the MFA code and/or request is valid. The confidence score is preferably derived using a weighted score based on evaluation factors such as active service alignment (e.g., Twitch MFA with Twitch activity), the temporal proximity of user action (e.g., login click within last 10 seconds), the trustworthiness of the sender (e.g., verified domain), the ambiguity or absence of a matching context, a domain mismatch or suspicious source. Each factor may include a numerical ranking, with a single confidence score based on an average, or weighted average, of the individual factor scores. In other embodiments different or additional factors may be included in the calculation of the confidence score. In further embodiments, the scoring model may be configurable or dynamically adjusted based on past outcomes, user feedback, or enterprise policy.

At block 306, the module determines whether the calculated score exceeds a predefined threshold (e.g., 70 for “valid”, 30-69 for “suspicious”, below 30 for “malicious”, on a 100 scale). With the confidence score computed, at block 308 that score, along with any notes or recommendations, are transmitted to the response and alerting module for action.

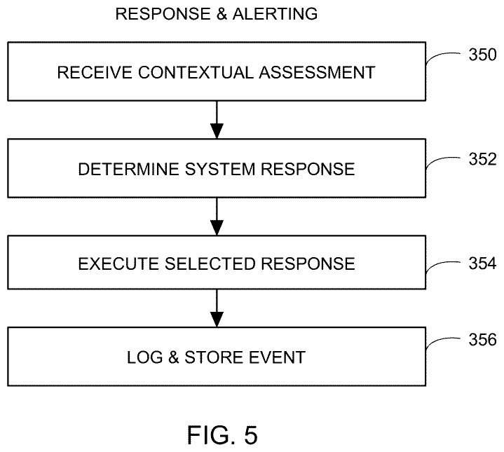

Turning to FIG. 5, a flow diagram of an exemplary embodiment of steps performed by the response and alerting module 122 is depicted. As discussed briefly above, this module evaluates the confidence score and other information provided and applies a response appropriate to the perceived risk level of the MFA event.

At block 350, the module receives the contextual assessment and evaluates the confidence score or severity classification. The evaluation may include a review of the confidence score, any flags or notes included with the score (e.g., trusted, unknown, suspicious), and any policy overrides defined by the user or an administrator.

At block 352, the module determines the appropriate system response, such as “Allow”, i.e., the MFA message is presented to the user normally; “Suppress”, i.e., the MFA code or notification is hidden or delayed pending user review and verification. ; “Alert”, i.e., a warning message is displayed to inform the user of a context mismatch and likely threat; “Delete”, i.e., the MFA message is removed from view or from the messaging system (if permitted by, for example, an administrator); and “Quarantine”, i.e., the MFA message is preserved for administrative review but is hidden from user notifications.

At block 354, the selected response is executed and alerts are generated via the user interface module 136. Depending on the assessed threat, alerts preferably include instructive text to the user, such as “You received a login code from Facebook, but no Facebook-related activity was detected on your device. This may indicate a phishing attempt.”

At block 356, the module logs the event, including the original MFA message metadata, user context snapshot, confidence score, system response, and user acknowledgment or override (if applicable). This information is preferably stored locally in user storage 138, or in some embodiments may be transmitted to a centralized server for further system training, reporting, or auditing.

As just described, the flow diagrams described above represent exemplary embodiments of the detection and response mechanisms and modules used in the system. In other embodiments, these steps and flows may be extended or modified based on platform capabilities, message formats, or additional data sources.

It should be understood that the described flows and scores are examples and may vary depending on the implementation context. In some embodiments, additional scoring inputs, such as device location, network risk level, or time-of-day heuristics, may be used to further refine the assessment of each MFA message.

Thus, as just described, the method implemented with reference to FIGS. 2 through 5 enables real-time, context-aware detection of suspicious MFA requests and implements proactive user protection against emerging MFA credential interception and theft techniques. The system and method thus provide an additional layer of MFA security without requiring modification to the underlying MFA authentication mechanisms as currently implemented by service providers.

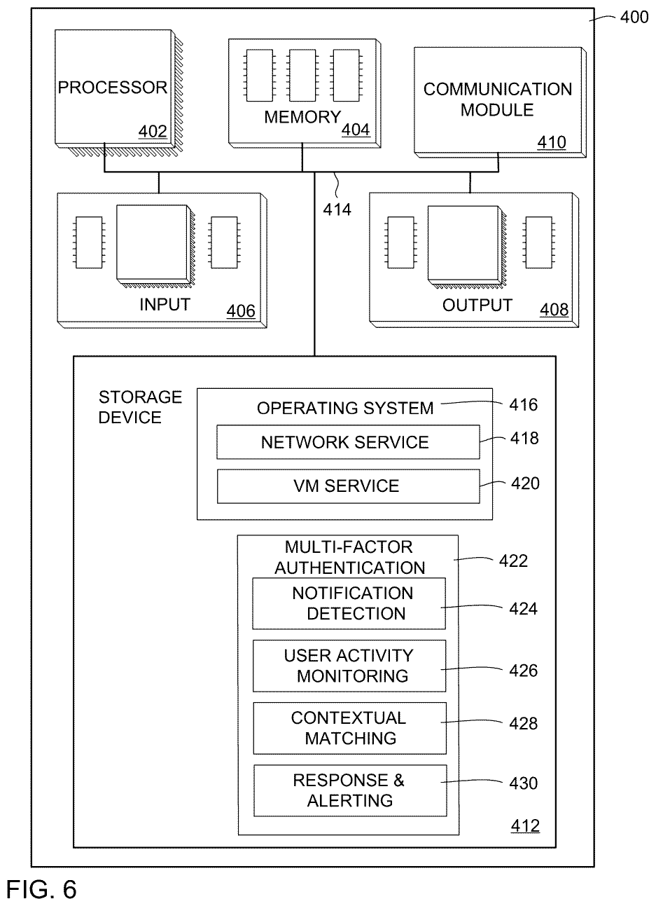

Turning to FIG. 6, a diagram of an exemplary computerized user device 400 for use with the system and method of the present invention is depicted, such as a user device similar to user device 124 or computing device 125 of FIG. 1, that allows an authorized user access. Device 400 is representative of any computing platform operable to connect users to accounts and MFA systems and execute the system and method described herein. This may include smartphones, tablets, laptops, desktop computers, or any similar computing devices capable of communication and real-time message handling.

While user device 400 is shown as a standalone computing device, computing device 400 may be any component or system that includes one or more processors or another suitable computing environment for executing software instructions in other examples, and need not include all of the elements shown here.

As shown in FIG. 6, computing device 400 includes one or more processors 402, a memory 404, input devices 406, output devices 408, a communication module 410, and a storage device 412. These components are communicatively coupled by one or more communication channels 414, which may include a system bus, interconnect network, or memory controller. Device 400 may further include an operating system 416 which may include services such as a network service 418 and a virtual machine service 420 such as a virtual server. One or more applications, such as a multi-factor authentication module 422 comprising a notification detection module 424, a user activity monitoring module 426, a contextual matching module 428, and a response & alerting module 430 similar to those modules as described with respect to FIG. 1.

Processor(s) 402 are configured to implement functionality and execute instructions for the various modules described above. These processors may include one or more general-purpose microprocessors, application-specific integrated circuits (ASICs), digital signal processors (DSPs), or field-programmable gate arrays (FPGAs), depending on the platform. For mobile devices, processor 402 may comprise a system-on-chip (SoC) including multiple execution cores for application processing and signal processing.

Memory 404 and storage 412 together provide the working and persistent memory resources used by device 400. Memory 404 typically includes volatile memory, such as random-access memory (RAM), while storage 412 includes non-volatile memory such as flash memory, solid-state drives (SSDs), or magnetic media. These components store the operating system, system modules, application logic, cached messages, and activity logs generated by the MFA threat detection system.

Input devices 406 may include any mechanism for receiving user input, such as a touchscreen, physical keyboard, mouse, microphone, fingerprint sensor, or hardware button array. These interfaces allow users to respond to system alerts, review blocked MFA attempts, or adjust configuration settings. In mobile environments, touchscreen input and biometric verification (e.g., fingerprint or face recognition) may be used for rapid interaction with MFA alerts or override prompts.

Output devices 408 provide visual, auditory, or haptic feedback to the user. These may include a display screen, speaker, LED indicator, vibration motor, or status light. For example, if the system blocks an MFA code due to contextual mismatch, a full-screen warning may be presented to the user, accompanied by a vibration pattern and confirmation dialog. Output intensities may vary by the calculated severity of the potential threat and by user preference settings.

Communication module 410 enables device 400 to send and receive data over public or private networks, such as the Internet, a local area network (LAN), a wireless network (e.g., WiFi, LTE, 5G), or Bluetooth. The communication module is configured to retrieve MFA messages (e.g., via SMS, email servers, or push notifications) and may also be used to transmit data logs or policy updates to a centralized server or enterprise security platform.

Operating system 416 provides low-level services and APIs needed by the detection system, including access to notification listeners, usage statistics, accessibility events, and messaging channels. On Android, the operating system may present interfaces such as NotificationListenerService, UsageStatsManager, and AccessibilityService, while on desktop environments, access to browser tabs and input focus may be provided through system calls or browser extension APIs.

The multi-factor authentication module 422 preferably includes visual and interactive components used by the end-user to review system behavior and alerts, such as a dashboard showing recent MFA activity and system decisions; configuration toggles for adjusting sensitivity or whitelisting senders; alert detail views with context explanation (e.g., “No matching app or website was active when this code was received”); and recovery controls for restoring falsely blocked messages or overriding automatic decisions

In combination, the components and modules as depicted in FIG. 6 enable computing device 400 to operate as a self-contained MFA detection platform, or as a client in a distributed system.

Preferably, in operation, as the user interacts with MFA events and the system responds based on contextual analysis, the system simultaneously collects data and user feedback to refine its performance over time. This is preferably achieved through an adaptive learning and feedback loop, which analyzes event outcomes to improve future decision-making, scoring accuracy, and user satisfaction. The adaptive learning and feedback capabilities are preferably implemented as a persistent software component, which may operate as a separate module or as part of the contextual matching module 428. This module continuously monitors the interaction history between the user, received MFA messages, and the system's response classifications.

For each intercepted MFA event, the system preferably logs the parsed metadata of the MFA message (e.g., sender ID, delivery method), the active app or browser tab context at time of message receipt, the confidence score and classification outcome (e.g., “valid”, “suspicious”), the system's response (e.g., allowed, suppressed, alerted, deleted), and the user's subsequent action (e.g., override, dismiss, report false positive). These logs are preferably stored locally in storage 412 and may optionally be uploaded to a cloud accessible server for further evaluation across users or across managed enterprise environments.

Based on the collected and aggregated data, the system may compute operational metrics which may be used to tailor future configurations, such as tracking the percent of malicious messages correctly blocked; the percent of legitimate messages incorrectly flagged; the frequency of user reversal of system decisions; and the accuracy of confidence scores compared to actual user engagement. In some embodiments, these metrics may be fed back into the system's scoring calculations, which may adjust individual weighting coefficients, decision thresholds, or feature priorities.

For example, if the system learns that users often engage with certain apps (e.g., PayPal or bank apps) in nonstandard contexts (e.g., while using split-screen mode), it may increase tolerance for those context mismatches. In some embodiments, the system may include a training interface through which users can manually review, approve, or correct past classification decisions. This user input may be used to add exceptions or whitelisted services; refine domain mappings (e.g., accept mail.googlemail.com as valid for Google); and adjust notification severity (e.g., suppress mild alerts, elevate critical ones).

In enterprise or managed deployments, administrators may further define organization-wide policy feedback rules, such as blocking all MFA codes not matching known enterprise app domains; requiring secondary verification (e.g., biometric) for mismatched MFA attempts; and logging all alerts for compliance or audit purposes.

In some embodiments, the system may further incorporate time-based heuristics and behavioral profiles to further optimize detection performance. For example, a user who always checks banking apps during lunch hours may receive higher scores for such activity in that timeframe. Or, a sudden change in device usage patterns (e.g., new geographic region, app not used before) may reduce confidence and trigger more aggressive blocking.

Using this continuous feedback cycle, the system may be trained to be more effective at distinguishing between legitimate and malicious MFA events. Thus, over time, false positives are reduced, real threats are more reliably identified, and user trust in MFA is reinforced.

As just described, the system and method of the present invention are well suited for identifying and preventing theft or misuse of MFA codes using contextual correlation of the MFA codes with corresponding user activity. It should be understood, however, that while the embodiments described herein are with respect to MFA codes and authentication, the system and method of the present invention may be adapted to work in other authorization fields. For example, the system and method may be adapted to process and evaluate other time-sensitive security communications, such as password reset (via emails or SMS links); device login alerts, suspicious login warning emails, account recovery alerts, and other similar alerts that are correlated with user activity.

Although specific embodiments have been illustrated and described herein, any arrangement that achieves the same purpose, structure, or function may be substituted for the specific embodiments shown. This application is intended to cover any adaptations or variations of the example embodiments of the invention described herein. These and other embodiments are within the scope of the following claims.

1. A system for identifying and preventing theft of multi-factor authentication (MFA) credentials, comprising:
a processor;
a memory;
a storage medium configured to store program instructions; and
a multi-factor authentication module executable by the processor, the multi-factor authentication module comprising:
a notification detection module configured to detect and parse incoming MFA messages received via SMS, email, or app notification;
a user activity monitoring module configured to determine a current application or browser tab in use on a user device at a time of message receipt;
a contextual matching module configured to compare a source of the MFA message to the current application or domain in use and generate a contextual confidence score; and
a response and alerting module configured to suppress, alert, or block the MFA message based on the contextual confidence score.

2. The system of claim 1, wherein the notification detection module is further configured to extract sender metadata and map the MFA message to a known service provider using a pre-established database.

3. The system of claim 1, wherein the user activity monitoring module utilizes platform-specific APIs to determine the foreground application or browser context in real-time.

4. The system of claim 1, wherein the contextual matching module computes the contextual confidence score based on weighted factors comprising service alignment, interaction recency, and domain verification.

5. The system of claim 1, wherein the response and alerting module deletes or hides the MFA message when a suspicious context is detected.

6. The system of claim 1, wherein the response and alerting module generates a user-facing alert when a mismatch is detected between the MFA source and the user's current activity.

7. The system of claim 1, wherein the multi-factor authentication module further comprises a logging component configured to store message metadata, activity snapshots, confidence scores, and system responses.

8. The system of claim 1, wherein the notification detection module and the user activity monitoring module operate simultaneously and in real-time.

9. The system of claim 1, wherein the multi-factor authentication module operates in parallel threads or asynchronous services to support real-time operation.

10. The system of claim 1, wherein the contextual matching module is further configured to generate the contextual confidence score in real-time based on a timestamped correlation between the MFA message and user activity.

11. A method for detecting and preventing theft of multi-factor authentication (MFA) credentials on a user device, the method comprising:
detecting, by a processor, an incoming MFA message received via SMS, email, or app notification;
identifying, by the processor, a service provider associated with the MFA message;
monitoring, by the processor, current user activity including a current application or domain in use at a time of message receipt;
comparing, by the processor, the service provider to the current user activity to determine a contextual match;
generating, by the processor, a contextual confidence score based on the comparison; and
executing, by the processor, a response comprising suppressing, alerting, or blocking the MFA message based on the contextual confidence score.

12. The method of claim 11, further comprising parsing the MFA message to extract metadata including a sender address, domain name, or app tag.

13. The method of claim 11, wherein monitoring current user activity comprises querying a platform-specific API to determine a currently focused application or browser tab in real-time.

14. The method of claim 11, wherein the response comprises generating a user alert indicating a mismatch between the MFA message and the user's current activity.

15. The method of claim 11, further comprising storing a log of the MFA message, activity context, contextual confidence score, and response action.

16. The method of claim 11, wherein determining the contextual match comprises simultaneous analysis of the MFA message metadata and user activity at the time of receipt.

17. A non-transitory computer-readable medium storing instructions that, when executed by a processor, cause the processor to perform a method comprising:
detecting an incoming MFA message on a user device;
identifying a service provider associated with the MFA message;
capturing user activity data at the time of message receipt;
comparing the service provider to the user activity data to evaluate consistency;
generating a contextual confidence score based on the comparison; and
executing a suppression, alert, or blocking action if the user activity is inconsistent with the service provider.

18. The non-transitory computer-readable medium of claim 17, wherein the instructions further cause the processor to determine the current application or browser tab using a platform-specific API.

19. The non-transitory computer-readable medium of claim 17, wherein the suppression action comprises hiding the MFA message or preventing display to the user.

20. The non-transitory computer-readable medium of claim 17, wherein the comparison and score generation are performed in real-time and based on a timestamped correlation.
